(19) United States
(12) Patent Application Publication
(10) Pub. No.: US 2002/0041932 A1
(43) Pub. Date: Apr. 11, 2002

(54) Method of preparing porous materials

(76) Inventor: Miki Ogawa, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/910,886

(22) Filed: Jul. 24, 2001

(30) Foreign Application Priority Data
Jul. 25, 2000 (JP) 2000-223642
Dec. 15, 2000 (JP) 2000-382545
Jul. 2, 2001 (JP) 2001-200895

(51) Int. Cl. B05D 1/18; B05D 3/02

(52) U.S. Cl. 427/376.2; 427/430.1; 427/256; 427/243

(57) ABSTRACT

A method of preparing a continuous and uniform mesostructured silica film with uniaxially aligned channel structure. The method includes the steps of making a solution containing silicon and surfactant be in contact with a substrate having alignment control ability and drying the substrate made in contact with the solution to remove the solvents contained in the solution.

### BACKGROUND OF THE INVENTION

1. Field of the Invention

The present invention relates to a method of preparing porous, the invention relates to applications of porous inorganic oxides which are used as catalysts, adsorbents and the like. In particular, the invention relates to the technology of preparing mesostructured silica film and mesoporous silica film and also to the technology of patterning mesostructured silica and meso-porous silica in which the tubular pores are uniaxially aligned into desired shape at desired positions on a substrate.

2. Related Background Art

Porous material is used in various fields such as adsorption and separation. According to IUPAC, porous materials are classified into the following three categories by their pore sizes. Micro-porous materials; the size of pores is 2 nm or smaller, meso-porous materials; 2 to 50 nm, and macro-porous materials; 50 nm or larger.

Mesoporous silicas which have regularly arranged uniform mesopores are invented independently by two groups through different methods. One is called as MCM-41, which is synthesized by hydrolyzing silicon alkoxide under the existence of surfactants, as described in “Nature”, Vol. 359, p. 710. The other is called as FSM-16, which is synthesized through intercalating alkylammonium into the interlayer spaces of kanemite, a layered silicateas described in “Journal of Chemical Society Chemical Communications”, Vol. 1993, p. 680.

Meso-porous silicas with regular porous structure exhibits various macroscopic morphologies such as thin films, fibers, fine spheres, and monoliths. Because of the controllability of such macroscopic morphologies, meso-porous silica is expected to be applied not only to catalysts and adsorbents but also to functional materials such as optical and electronic materials.

Mesoporous silica films can be prepared using varius strategies. For example-spin coating, described in “Chemical Communications”, Vol. 1996, p. 1149, dip coating, described in “Nature”, Vol. 389, p. 364, methods based on heterogeneous nucleation and growth at solid-liquid interfaces, described in “Nature”, Vol. 379, p. 703 have been employed.

However, the methods using spin coating and dip coating provide mesoporous silica films with random pore orientation, and those based on heterogeneous nucleation and growth require long reaction time

### SUMMARY OF THE INVENTION

The structural anisotropy based upon the preferred orientation of the pores (nano holes) is very important in terms of applications of mesoporous silica films to optical and electronic materials.

An object of the present invention is to provide a method of forming uniform porous materials (including “meso-structured materials” or “meso-porous materials”) with plural pores substantially aligned along one direction (uniaxial orientation), in short time, and with low cost.

Another object of the invention is to provide a method of forming porous materials (including “meso-structure materials” or “meso-porous materials”) with highly aligned porous structure onto a substrate at a desired position and in a desired shape.

According to one aspect of the present invention, there is provided a method of preparing porous materials, comprising the steps of: making a solution containing silicon and surfactant be in contact with a substrate having alignment control ability; and drying the substrate made in contact with the solution to remove the solvents contained in the solution.

According to another aspect of the present invention, there is provided a method of preparing porous materials, comprising the steps of: coating a substrate having alignment control ability with a surfactant solution containing silicon alkoxide; and drying the substrate.

According to another aspect of the present invention, there is provided a method of preparing porous materials comprising the steps of: coating a substrate having alignment control ability with a surfactant solution containing silicon alkoxide; and drying the substrate; and removing the surfactant.

According to a further aspect of the present invention, there is provided a method of preparing porous materials, comprising the steps of: attaching a solution containing silicon and surfactant to a substrate having alignment control ability; and drying the substrate attached to the solution to remove the solvents contained in the solution.

Patterned porous materials with uniaxially aligned pores can be formed by a step of coating desired positions of a substrate having alignment control ability with a solution containing silicon and surfactant and a step of drying the substrate.

### BRIEF DESCRIPTION OF THE DRAWINGS

FIG. 1 is a schematic view showing an LB film preparation system to be used in the present invention.

FIG. 2 is a schematic view showing a coating pattern of the reactant solution according to an embodiment of the present invention.

FIG. 3 is a schematic view showing a pattern of the transparent mesostructured silica thin film on a substrate according to an embodiment of the present invention.

FIG. 4 is a schematic view showing a pattern of the hydrophobic region according to a seventh embodiment of the present invention.

### DETAILED DESCRIPTION OF THE PREFERRED EMBODIMENTS

A preparation method according to the invention will be described. By using the following processes (A) to (C), mesostructured silica in which the pores are uniaxially aligned can be formed. By using the following processes (A) to (D), mesoporous silica in which the pores are uniaxially aligned can be formed formed.

Process (A)

First, a substrate is prepared whose surface has alignment control ability.

It is preferable in this invention to use a substrate which has regularity at an atomic level such as (110) plane of silicon single crystal and cleaved surfaces of mica and graphite. Since such substrates haves intrinsic alignment control ability, they can be used without further treatment.

General substrates such as a glass substrate can be employed in the present invention after a treatment to provide alignment control ability. Although the material of the substrate to which the treatment is applied is not specifically limited, it is preferable that the substrate is stable under acidic conditions. For example, silica glass, ceramics, resin and the like can be used.

An example of the treatment to provide alignment control ability to above-mentioned general substrates is a forming of rubbing-treated polymer film (coating). In this rubbing process, a polymer film on a substrate prepared by spin coating or the like is rubbed with cloth. The rubbing cloth is generally attached around a roller(rubbing roller). The rubbing treatment is made by pressing the rotating rubbing roller on the polymer-coated substrate.

In this invention, in place of the rubbing-treated polymer compound film, a Langmuir-Blodgett film (LB film) can be used. As compared to the above-mentioned rubbing-treated polymer compound films, LB films provides more uniform substrate surfaces although it takes a longer time to prepare LB films. In some cases, the rubbing process is associated with a problem of scratches depending upon the rubbing conditions. By using an LB film, a substrate surface having considerably less defects can be obtained.

Because the coating process with a reactant solution, to be described later, is made for more uniform surfaces, structurally more uniform mesostructured silica and mesoporous silica is obtainable.

LB films are prepared by transferring a Langmuir monolayer that is developed on a water surface onto a substrate. By repeating the film deposition process, LB films with desired number of layers can be formed.

The LB film in this invention intends to include a film consists of single-molecule lamination film of an LB film derivative which is formed by making an LB film formed on a substrate be subjected to a process such as a heat treatment to change chemical structure while the layered structure is maintained.

A general method is used for preparing an LB film.

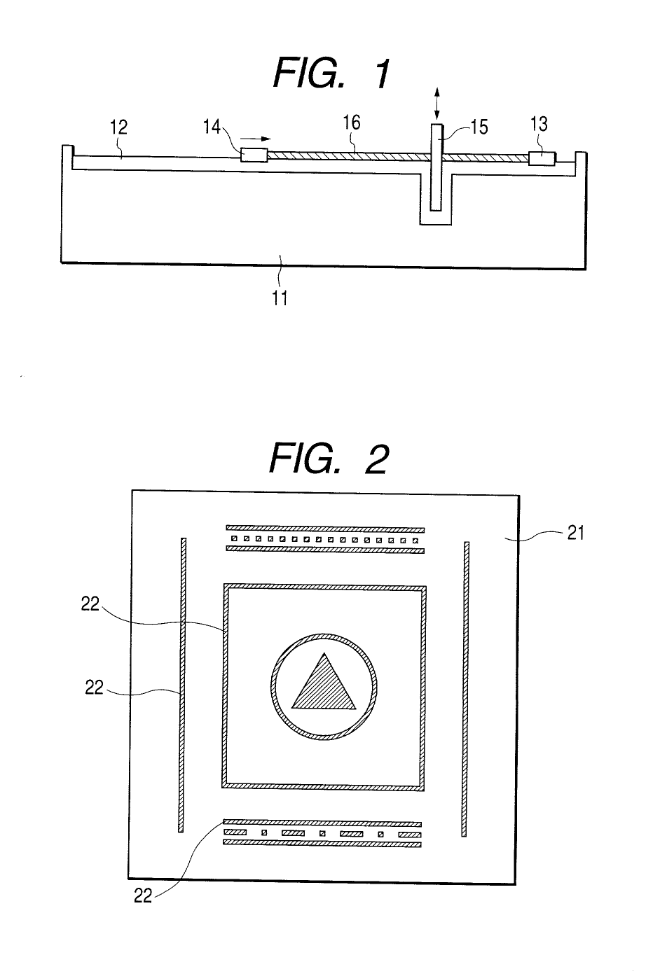

A general LB film preparation system is schematically shown in FIG. 1. Referring to FIG. 1, reference numeral 11 represents a water trough filled with pure water 12. Reference numeral 13 represents a fixed barrier with an unrepresented surface pressure sensor. A monolayer 16 on the water surface is formed by dispensing solution of the target substance or precursor of the target substance onto the water surface between the variable barrier 14 and the fixed barrier 13. By moving the variable barrier 14, surface pressure is applied. The position of the variable barrier 14 is controlled by the surface pressure sensor so that constant surface pressure is applied while the film is transferred onto a substrate 15.

Pure water is supplied by unrepresented water supply and drain apparatus to keep the solution clean.

A recession is formed in the trough 11 and a substrate 15 is held at this position. The substrate can be moved up and down at a constant speed by an unrepresented translation apparatus. A film on the water surface is transferred onto the substrate when the substrate is dipped into the water and withdrawn from the water.

The LB film of the present invention is formed using such a system in which the substrate 15 is dipped into and withdrawn from the water one after another while a surface pressure is applied to a monolayer developed on the water surface.

The shape and the quality of the film are controlled by surface pressure, speed of the substrate movement for dipping/withdrawing, and the number of layers. The optimum condition of the surface pressure during the LB film deposition is determined from a surface area surface pressure curve, and generally set to a value of several mN/m to several tens mN/m. The speed of the substrate motion is generally several mm/min to several hundreds mm/min.

The method described above is generally used as an LB film preparation method. However, the method of preparing an LB film employed in the present invention is not limited to that. For example, a method using a sub-phase water flow can also be used.

Although the material of the substrate on which an LB film is formed is not specifically limited, it is preferable that the substrate is stable under the acidic conditions. For example, silica glass, ceramics, resin and the like can be used.

Process (B)

Next, a solution (reactant solution) containing silicon and surfactant is made in contact with (attached to) the surface having alignment control ability.

Any well known coating method can be employed for the method of making the reactant solution be in contact with the substrate. For example, spin coating, dip coating or the like can be used. Other methods can also be used so long as they can make the reactant solution be in contact with the substrate.

Dip coating is convenient because it affords facile coating in a short time. According to this method, a substrate is dipped into a reactant solution and subsequently withdrawn from it, affording the formation of a highly uniform coating. The coating amount, i.e., the thickness of the thin film to be formed, can be controlled, for example, by a substrate withdrawing speed.

In the solution used in the present invention, a mixed solvent of alcohol and water, e.g., ethanol and water is preferably used. Other solvents can also be used as long as they can dissolve the surfactants and the silicon compounds (e.g., silicon alkoxide).

Surfactants are added to the above-mentioned solvent at concentrations lower than the corresponding critical micelle concentration.

Acid such as hydrochloric acid is added to the surfactant solution to adjust its pH to nearly 2 which is an isoelectric point of SiO₂, and then a silicon alkoxide such as tetraethoxysilane and tetramethoxysilane is added to prepare the final reactant silica sol solution.

The surfactant is selected as desired. For example, cationic surfactants such as quaternary alkylammonium and nonionic surfactants containing polyethylene oxide as a hydrophilic group are favorably used. The length of the surfactant molecule is determined according to the size of the mesopores of the objective mesostructure. In order to expand the micelle size, additive such as mesitylene can be added.

In the acid side, particularly near at the isoelectric point, condensation of SiO₂ is slow, and the precipitation is not generated immediately after the addition of the alkoxide, in contrast with the reaction under basic conditions.

Description will be given in this invention a method of forming a porous materials (e.g., mesostructured silica, meso-porous silica) patterned into a desired shape on a substrate.

Patterning is performed by selectively coating a substrate with the reactantsolution by ink jet, pen lithography or the like and subsequent drying process.

Pen lithography is convenient for making continuous pattern such as line patterns.

According to pen lithography, the reactant solution is used like ink and is deposited on a substrate from a pen tip to draw a line. It is possible to freely change the line width by changing the pen shape, motion speed of the pen or the substrate, the rate of the reactant solution supply to pen, and the like. It is possible to draw a line with a width from μm order to mm order. It is possible to draw a desired pattern including straight lines and curves. A two-dimensional pattern can also be drawn by overlapping the lines.

When a pattern having discontinuous dots is to be drawn, ink jet is more convenient. In the ink jet method, the reactant solution is used like ink and is ejected out from an ink jet nozzle as a droplet having a constant volume, and is deposited on a substrate. A two-dimensional pattern can also be drawn by overlapping the positions of the deposition.

Presently, the ink jet technology enables the control of the ejection volume of one droplet in a pl order, providing very fine dots. The ink jet method is advantageous for pattering fine dots.

With these coating methods including the pen lithography and the ink jet, a desired pattern can be drawn easily by using a computer system such as CAD. Therefore, these coating methods are very advantageous for forming various patterns on various substrates in terms of manufacture efficiency comparing to the usual photolithography which needs various photo-masks for different patterns.

The patterning is possible also by a dip coating method. In this case, hydrophilic and hydrophobic regions are formed on the substrate having alignment ability. Because the reactant solution is a mixture of alcohol and water, only the hydrophilic region is selectively coated with the reactant solution even though whole of the substrate is dipped into the solution.

During the drying process after the coating process, alcohol first evaporates and the water concentration increases so that the reactant solution is selectively attracted to the hydrophilic region. Therefore, the mesostructured silica is formed only on the hydrophilic region so that a desired shape can be patterned at desired positions of the substrate. The hydrophilic regions having alignment control ability defined on the substrate surface allow the mesopores in the patterned mesostructured silica align uniaxially. In this case, the patterned hydrophobic regions have to be hydrophobic enough comparing to the regions with the treatment for the alignment control.

An example of forming hydrophobic regions onto a substrate is forming a self-organizing mono-layered film of organo silanes onto the surface of a silicon single crystal. A method of patterning the self-organizing film may be already existing methods such as a method of stamping a solution in which self-organizing molecules are dissolved and a method of exposing UV light to the self-organizing film containing highly UV sensitive aromatic rings or mercapto groups.

Other methods such as photolithography using photo-resist films can be used for the patterning of the hydrophobic region. Any method can be used so long as it can form two regions on the substrate surface, one being able to be coated with reactant solution and the other being unable to be coated with reaction solution.

Process (C)

Next, the substrate is dried.

This process dries (evaporates) the solvent in the solution deposited on (attached to) the substrate. With this process, mesopores are formed. In this process, the solvent evaporates and the concentration of the surfactant exceeds the critical micelle concentration so that self-assembly of the surfactant starts. As the solvent further evaporates, self-organization of surfactant-silica assembly is promoted.

Since the substrate having alignment control ability is used, a mesostructured silica with uniaxially aligned mesopores can be formed not only near the interface between the substrate and the mesostructured silica film but also over all the thicknesses of the film.

The reason for this would be ascribed to that the inside of the thin film after the solvent evaporation is not in a complete solid state but in a semi-solid state that allow the microscopic movement of silica-surfactant assembly to the most stable configuration.

With the above processes (A) to (C), mesostructured silica can be formed.

According to the present invention, a process (D) have to be added to form meso-porous silica. This process removes the surfactant micells that exist within the pores.

As a method of removing the surfactants, calcination, extraction by solvents or the like can be used.

For example, calcination at 350° C. in air for 10 hours leads complete removal of the surfactant from mesostructured silica without destroying the porous structure and its uniaxial alignment.

If extraction by solvent is used, it is possible to form meso-porous silica on a substrate which is not resistant to calcinations, although it is difficult to remove 100% of the surfactant.

Other methods can also be used if they can remove the surfactant without destroying the silica meso structure and the alignment.

According to the preparation method of this invention described above, it is possible to form porous materials in which the longitudinal direction of the plural pores are substantially parallel each, with high uniformity, with ease and in a short time. In other words, meso-structured silica or meso-porous silica in which the tubular pores are uniaxially aligned can be formed with high uniformity, with ease and in a short time.

### EXAMPLES

The present invention will be described in more detail in connection with examples. The invention is not limited to only the embodiments, but the materials, reaction conditions and the like can be altered freely to the extent that meso-structured silica and meso-porous silica having similar structure are formed.

### Example 1

In this example, a silicon (110) single crystal wafer was used as a substrate to form a pattern of meso-structured silica with uniaxially aligned mesopores. First, the surface of the silicon (110) substrate having volume resistivity of 1 to 2 Ωcm was treated with an HF solution to remove the surface oxide.

Next, tetraethoxysilane (TEOS):ethanol:pure water:hydrochloric acid were mixed at a molar ratio of 1:3.8:1:5×10⁻⁵ and refluxed for 1.5 hours at 60° C.

Thereafter, polyoxyethylene-(10)-hexadecylether [C₁₆H₃₃(CH₂CH₂O)₁₀OH] dissolved in ethanol was mixed, and further ethanol, water and hydrochloric acid were added to dilute the mixed solution to afford the final molar ratio of TEOS:ethanol:pure water:hydrochloric acid:polyoxyethylene-(10)-hexadecylether to be 1:22:5:0.004:0.075.

The substrate was coated with this reactant solution by pen lithography method, as shown in FIG. 2, and was dried at room temperature. The conditions of pen lithography were as follows; the pen orifice of 50.0 μm, the substrate speed of 2.5 cm/s and the rate of the solution supply of 4.0 cm/s.

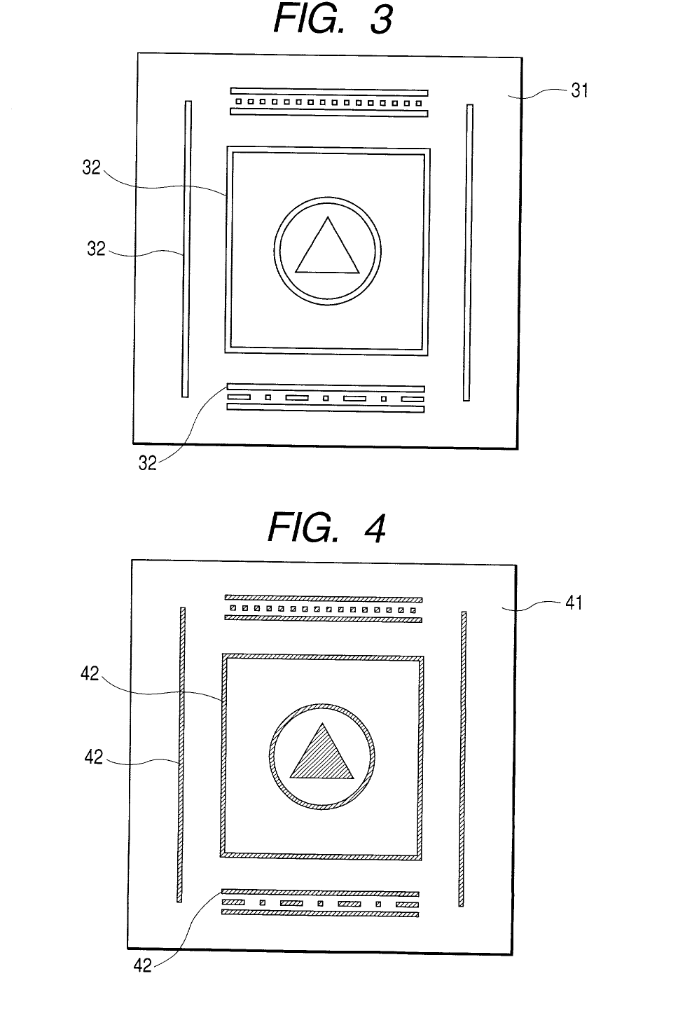

This substrate dried in air was observed and it was confirmed that transparent thin films were formed only in the region where the solution was deposited by pen lithography, as shown in FIG. 3. An x-ray diffraction analysis was made for the transparent thin film patterned on the substrate.

A diffraction peak correspond to the lattice distance of 6.2 nm assigned to be the (100) plane of the hexagonal mesostructured silica.

In order to quantitatively evaluate the alignment of the meso-channels in the mesostructured silica thin film, an in-plane x-ray diffraction analysis was made.

This method measures an in-plane rotation angle dependence of the x-ray diffraction intensity of (110) plane that is perpendicular to the substrate surface, and provide the information about the direction of the channel alignment and its distribution as described in “Chemistry of Materials”, Vol. 11, p. 1609.

The results of the in-plane x-ray diffraction analysis show that the mesostructured silica thin film formed by this embodiment have uniaxially aligned channel structure with the alignment distribution of about 29°, estimated from a value of the full-width-at-half-maximum of the diffraction profile.

It was therefore confirmed from these results that the method of the present invention could form mesostructured silica films with uniaxially aligned channel structure on a substrate at any desired position and in any desired shape.

The substrate on which the mesostructured silica films with aligned channel structure were formed was placed in a muffle furnace whose temperature was raised to 350° C. at a heating speed of 1° C./min to be calcined in air for 10 hours. The shape of the mesostructured silica after calcination did not show a large difference from that before calcination.

The x-ray diffraction analysis of the mesostructured silica after calcinations showed a diffraction peak corresponding to the lattice distance of 5.9 nm, which confirmed the retention of the hexagonal channel structure.

Analysis by infrared spectroscopy confirmed that no organic substance originated from the surfactant is remaining in the film after calcination. In this way, the formation of mesoporous silica films was confirmed. An in-plane x-ray diffraction analysis was made also for the patterned meso-porous silica silica films after calcination. The in-plane rotation angle dependence of the (110) plane diffraction intensity was measured, which showed the alignment distribution of about 29°. It was confirmed from these results that the mesostructured silica formed by the embodiment retained the alignment of the mesochannels almost completely after calcination.

From the above results, it was confirmed that the invention method could form mes porous silica films with uniaxially aligned pore structure on a substrate at any desired position and in any desired shape.

### Example 2

This example formed a pattern of mesostructured silica with uniaxially aligned mesopores by using a silica glass substrate with a rubbing treated polymer thin film.

First, a silica glass substrate was washed with acetone, isopropylalcohol and pure water, and subsequently, the surface of the substrate was cleaned in an ozone generator system. Thereafter, the substrate was coated with an NMP solution of the corresponding polyimide precursor, polyamic acid A by spin-coating and baked for one hour at 200° C. to convert into the polyimide A having the following structure.

(Polyimide A)

This substrate was subjected to a rubbing process along one direction over the whole area under the conditions shown in Table 1. This substrate was used for the preparation of mesostructured silica.

TABLE 1
Rubbing conditions for polyimide A

| Cloth material | Nylon |
|---|---|
| Roller diameter (mm) | 24 |
| Depression (mm) | 0.4 |
| Rotation Speed (rpm) | 1000 |
| Stage speed (mm/min) | 600 |
| Repetition | 2 |

Next, similar to the Example 1, a reactant solution was prepared and deposited on the substrate by an ink jet method to form a similar pattern to that of the Example 1 shown in FIG. 2, and dried at the room temperature. Reference numeral 22 represents the pattern of the reactant solution on the substrate 21.

The substrate after drying in air was observed. It was confirmed that thin films such as shown in FIG. 3 were formed only in a region where the solution was applied from an ink jet nozzle. Reference numeral 32 represents a transparent thin film pattern on the substrate 31.

An x-ray diffraction analysis was made for the patterned thin films on the substrate and approximately similar results to those of the Example 1 were obtained. It was confirmed that the thin films consist of mesostructured silica having hexagonal channel structure.

In order to quantitatively evaluate the alignment of the mesochannels in the mesostructured silica thin films, an in-plane x-ray diffraction analysis was made by a similar method to that of the Example 1.

The results of the in-plane x-ray diffraction analysis show that the mesostructured silica thin films formed by this embodiment have uniaxially aligned channel structure with the alignment distribution of about 13°, estimated from a value of the full-width-at-half-maximum of the diffraction profile. It was therefore confirmed that the method of the present invention could form mesostructured silica films with uniaxially aligned channel structure on a substrate at any desired position and in any desired shape.

It was also confirmed that the distribution of the alignment of about 13° was very narrow as compared to the Example 1, showing the excellent alignment.

The substrate on which the mesostructured silica films with aligned channel structure were formed was calcined by a method similar to the Example 1. The shape of the mesostructured silica after calcinations did not show a large difference from that before calcination.

The x-ray diffraction analysis of the mesostructured silica after calcination-showed a diffraction peak corresponding to the lattice distance of 5.9 nm, which confirmed the retention of the hexagonal channel structure.

Analysis by infrared spectroscopy confirmed that no organic substance originated from the surfactant is remaining in the film after calcination. In this way, the formation of the mesoporous silica films was confirmed.

An in-plane x-ray diffraction analysis was made also for the patterned meso-porous silica films after calcination. The in-plane rotation angle dependencey of the (110) plane diffraction intensity was measured, which showed the alignment distribution of about 13°. It was confirmed that the mesostructured silica films formed by the embodiment retained the alignment of the mesochannels almost completely after calcination.

From the above results, it was confirmed that the method of the present invention could form meso-porous silica films with uniaxially aligned pore structure on a substrate at any desired position and in any desired shape.

### Example 3

This example formed a pattern of mesostructured silica thin films with uniaxially aligned mesopores by using a substrate with an LB film of polyimide A having the same structure as that of the Example 2.

Polyamic acid A and N,N-dimethylhexadecylamine were mixed at a mol ratio of 1:2 to form N,N-dimethylhexadecylamine salt of polyamic acid A. This salt was dissolved in N,N-dimethylacetoamide to form a solution of 0.5 mM. This solution was dispensed on a water surface in an LB film preparation system maintained at 20° C. A monolayer (thickness of single molecule) film formed on the water surface was transferred onto the substrate at a dip speed of 5.4 mm/min with constant surface pressure of 30 mN/m.

A silica glass substrate was used as the substrate, after washing with acetone, isopropylalcohol and pure water, and subsequently, the surface was cleaned in an ozone generator system.

After the LB film consists of thirty layers of the polyamic acid alkylamine salt was formed on the substrate, this substrate was baked for 30 minutes at 300° C. under a nitrogen gas flow to form an LB film of polyimide A. Transformation of polyamic acid to polyimide through dehydration ring closure and desorption of alkylamine were confirmed by infrared spectroscopy.

A Reactant solution similar to that of the Example 1 was prepared and deposited on the substrate by an ink jet method to form a similar pattern to that of the Example 1 shown in FIG. 2, and dried at the room temperature.

The substrate after drying in air was observed. It was confirmed that thin films such as shown in FIG. 3 was formed only in a region where the solution was applied from an ink jet nozzle.

An x-ray diffraction analysis was made for the patterned thin films on the substrate and approximately similar results to those of the Example 1 were obtained. It was confirmed that the thin films consist of mesostructured silica having hexagonal channel structure.

In order to quantitatively evaluate the alignment of the mesochannels in the mesostructured silica thin films, an in-plane x-ray diffraction analysis was made by a similar method to that of the Example 1.

The results of the in-plane x-ray diffraction analysis show that the mesostructured silica thin films formed by this embodiment have uniaxially aligned channel structure with the alignment distribution of about 12°, estimated from a value of the full-width-at-half-maximum of the diffraction profile.

It was therefore confirmed that the method of the present invention could form a mesostructured silica films with uniaxially aligned channel structure on a substrate at any desired position and in any desired shape.

The substrate on which the mesostructured silica films with aligned channel structure were formed was calcined by a method similar to the Example 1. The shape of the mesostructured silica after calcinations did not show a large difference from that before calcinations.

The x-ray diffraction analysis of the mesostructured silica after calcination showed a diffraction peak corresponding to the lattice distance of 5.9 nm, which confirmed the retention of the hexagonal channel structure.

Analysis by infrared spectroscopy confirmed that no organic substance originated from the surfactant is remaining in the films after calcination. In this way, the formation of mesoporous silica films was confirmed.

An in-plane x-ray diffraction analysis was made also for the patterned mesoporous silica films after calcination. The in-plane rotation angle dependence of the (110) plane diffraction intensity was measured, which showed the alignment distribution of about 12°. It was confirmed that the mesostructured silica formed by the embodiment retained the alignment of the mesochannels almost completely after calcination.

From the above results, it was confirmed that the invention method could form a mesoporous silica films with uniaxially aligned pore structure on a substrate at any desired position and in any desired shape.

### Example 4

In this example, a silicon (110) single crystal was used as a substrate to form a mesostructured silica thin film with uniaxially ligned mesopores by dip-coating.

First, the surface of the silicon (110) substrate having volume resistivity of 1 to 2 Ωcm was treated with an HF solution to remove the surface oxide.

Next, tetraethoxysilane (TEOS):ethanol:pure water:hydrochloric acid were mixed at a molar ratio of 1:3.8:1:5×10⁻⁵ and refluxed for 1.5 hour at 60° C.

Thereafter, polyoxyethylene-(10)-hexadecylether [C₁₆H₃₃(CH₂CH₂O)₁₀OH] dissolved in ethanol was mixed, and further ethanol, water and hydrochloric acid were added to dilute the mixed solution to afford the final molar ratio of TEOS:ethanol:pure water:hydrochloric acid:polyoxyethylene-(10)-hexadecylether to be 1:22:5:0.004:0.075.

The substrate was coated with this reactant solution by dip coating method, and was dried at—room temperature. The withdrawal speed of the substrate was 8 cm/min.

This substrate dried in air was observed and it was confirmed that a continuous uniform thin film was formed over the whole substrate.

An x-ray diffraction analysis was made for the transparent thin film formed on the substrate. A diffraction peak correspond to the lattice of 6.1 nm assigned to be the (100) plane of the hexagonal mesostructured silica. It was confirmed that the transparent thin film consists of mesostructured silica having hexagonal channel structure.

In order to quantitatively evaluate the alignment of the mesochannels in the mesostructured silica film, an in-plane x-ray diffraction analysis was made by a similar method to that of the Example 1.

The results of the in-plane x-ray diffraction analysis show that the mesostructured silica thin film formed by this embodiment has uniaxially aligned channel structure with the alignment distribution of about 29°, estimated from a value of the full-width-at-half-maximum of the diffraction profile.

It was therefore confirmed from these results that the method of the present invention could form a mesostructured silica thin film with uniaxially aligned channel structure on a substrate.

The substrate on which the mesostructured silica films with aligned channel structure were formed was calcined by a method similar to the Example 1. The shape of the mesostructured silica after calcination did not show a large difference from that before calcination.

The x-ray diffraction analysis of the mesostructured silica after calcination showed a diffraction peaks corresponding to the lattice distance of 5.8 nm, which confirmed the retention of the hexagonal channel structure.

Analysis by infrared spectroscopy confirmed that no organic substance originated from the surfactant is remaining in this film after calcination. In this way, the formation of the mesoporous silica film was confirmed.

An in-plane x-ray diffraction analysis was made also for the mesoporous silica thin film after calcinatio. The in-plane rotation angle dependence of the (110) plane diffraction intensity was measured, which showed the alignment distribution of about 29°. It was confirmed from these results that the mesostructured silica film formed by the embodiment retained the alignment of the mesochannels almost completely after calcination.

From the above results, it was confirmed that the method of the present invention could form a mesoporous silica thin film with uniaxially aligned pore structure on a substrate.

### Example 5

This example formed a thin film of mesostructured silica with uniaxially aligned mesopores by using a silica glass substrate with a rubbing treated polymer.

First, a silica glass substrate was coated with an NMP solution of polyamic acid A by a similar method to that of the Example 2, and baked for one hour at 200° C. to convert into the polyimide A.

This substrate was subjected to a rubbing process along one direction over the whole area under the conditions shown in Table 1. This substrate was used for the preparation of mesostructured silica film.

Next, similar to the Example 1, a reactant solution was prepared and the substrate was coated with this solution by dip coating method, and was dried at room temperature. During the dip coating, the substrate was set so that the withdrawal direction of the substrate was perpendicular to the rubbing direction.

The substrate dried in air was observed. It was confirmed that a continuous uniform thin film was formed over the whole substrate.

An x-ray diffraction analysis was made for the transparent thin film formed on the substrate and approximately similar results to those of the Example 4 were obtained. From these results, it was confirmed that the transparent thin film consists of mesostructured silica having hexagonal channel structure.

In order to quantitatively evaluate the alignment of the mesochannels in the mesostructured silica, an in-plane x-ray diffraction analysis was made by a similar method to that of the Example 1.

The results of the in-plane x-ray diffraction analysis show that the mesostructured silica thin film formed by this embodiment has uniaxially aligned channel structure with the alignment distribution of about 14°, estimated from a value of the full-width-at-half-maximum of the diffraction profile. The channel direction was perpendicular to the rubbing direction of the substrate. It was therefore confirmed that the method of the present invention could form a mesostructured silica thin film with uniaxially aligned channel structure on a substrate.

It was also confirmed that the the distribution of the alignment of about 14° was very narrow as compared to the Example 4, showing the excellent.

The substrate on which the mesostructured silica film with aligned channel structure was was calcined by a method similar to the Example 1. The shape of the mesostructured silica after calcination did not show a large difference from that before calcination.

The x-ray diffraction analysis of the mesostructured silica film after calcination showed a diffraction peaks corresponding to the lattice distance of 5.9 nm, which confirmed the retention of the hexagonal channel structure.

Analysis by infrared spectroscopy confirmed that no organic substance originated from the surfactant is remaining in this film after calcination. In this way, the formation of the uniform and continuous mesoporous silica thin film was confirmed.

An in-plane x-ray diffraction analysis was made also for the mesoporous silica thin film after calcination. The in-plane rotation angle dependencey of the (110) plane diffraction intensity was measured, which showed the alignment distribution of about 13°. It was confirmed that the mesostructured silica film formed by the embodiment retained the alignment of the mesochannels almost completely after calcination.

From the above results, it was confirmed that the method of the present invention could form a mesoporous silica thin film with uniaxially aligned pore stucture on a substrate.

### Example 6

This example formed a mesostructured silica thin film with uniaxially aligned mesopores by using a substrate with an LB film of polyimide A having the same structure as that of the Example 2.

The LB film consists of thirty layers of the polyimide A was formed on a silica glass substrate using the same method as that of the Example 3.

A reactant solution similar to that of the Example 1 was prepared and the substrate was coated with this solution by dip coating method similar to the Example 4, and was dried at room temperature. During the dip coating, the substrate was set so that the withdrawal direction of the substrate was perpendicular to the direction of the substrate motion in the LB film deposition. The substrate dried in air was observed. It was confirmed that a continuous uniform thin film was formed over the whole substrate.

An x-ray diffraction analysis was made for the transparent thin film formed on the substrate and approximately similar results to those of the Example 4 were obtained. From these results, it was confirmed that the transparent thin film consists of mesostructured silica having hexagonal channel structure.

In order to quantitatively evaluate the alignment of the mesochannels in the mesostructured silica film, an in-plane x-ray diffraction analysis was made by a similar method to that of the Example 1.

The results of the in-plane x-ray diffraction analysis show that the mesostructured silica thin film formed by this embodiment has uniaxially aligned channel structure with the alignment distribution of about 12°, estimated from a value of the full-width-at-half-maximum of the diffraction profile. The channel direction was perpendicular to the direction of the substrate motion in the LB film deposition. It was therefore confirmed that the method of the present invention could form a mesostructured silica thin film with uniaxially aligned channel structure on a substrate.

The substrate on which the mesostructured silica film with aligned channel structure was formed calcined by a method similar to the Example 1. The shape of the mesostructured silica film after calcination did not show a large difference from that before calcination.

The x-ray diffraction analysis of the mesostructured silica film after calcination showed a diffraction peak corresponding to the lattice distance 5.9 nm, which confirmed the retention of the hexagonal channel structure.

Analysis by infrared spectroscopy confirmed that no organic substance originated from the surfactant is remaining. In this way, the formation of the uniform and continuous mesoporous silica thin film was confirmed.

An in-plane x-ray diffraction analysis was made also for the mesoporous silica thin film after calcination. The in-plane rotation angle dependence of the (110) plane diffraction intensity was measured, which showed the alignment distribution of about 12°. It was confirmed from this that the mesostructured silica film formed by the embodiment retained the alignment of the mesochannels almost completely after calcination.

From the above results, it was confirmed that the method of the present invention could form a mesoporous silica thin film with uniaxially aligned pore structure on a substrate.

### Example 7

In this example, similar to the Example 1, a silicon (110) single crystal wafer was used as a substrate. In this case, patterned self-organizing mono-layered films of organo silanes are formed on the silicon substrate surface to form a pattern of mesostructured silica thin film with uniaxially aligned channel structure.

As the self-organizing molecules, octadecyltrichlorosilane [CH₃(CH₂)₁₇SiCl₃] was used and patterned as shown in FIG. 4 by using a stamp method.

Reference numeral 41 represents the regions where the self-organizing film is patterned, and reference numeral 42 represents the regions where the surface of the silicon substrate is exposed. Since alkyl chains are exposed on the surface, the region where the self-organizing film of organo silanes is formed becomes a hydrophobic region. The hydrophobic region 41 and hydrophilic region 42 are therefore defined.

A reactant solution similar to that of the Example 1 was prepared and the substrate was coated with this solution by dip coating method similar to the Example 4, and was dried at room temperature.

The substrate dried in air was observed. It was confirmed that transparent thin films were formed only in the hydrophilic regions 42 as shown in FIG. 3 (32), providing the objective pattern of the films.

An x-ray diffraction analysis was made for the patterned transparent thin films formed on the substrate. Approximately similar results to those of the Example 1 were obtained and it was confirmed that the transparent thin films consist of mesostructured silica having hexagonal channel structure.

In order to quantitatively evaluate the alignment of the mesochannels in the mesostructured silica films, an in-plane x-ray diffraction analysis was made similar to the Example 1. The results of the in-plane x-ray diffraction analysis show that the mesostructured silica thin films formed by this embodiment have uniaxially aligned channel structure with the alignment distribution of about 30°, estimated from a value of the full-width-at-half-maximum of the diffraction profile. It was therefore confirmed from these results that the method of the present invention could form a mesostructured silica thin films with uniaxially aligned channel structure on a substrate at any desired position and in any desired shape.

The substrate on which the mesostructured silica film with aligned channel structure was formed was calcined by a method similar to that of the Example 1. The shape of the mesostructured silica films after calcination did not show a large difference from that before calcination.

The x-ray diffraction analysis of the mesostructured silica films after calcination showed a diffraction peak corresponding to the lattice distance of 5.9 nm, which confirmed the retention of the hexagonal channel structure.

Analysis by infrared spectroscopy confirmed that no organic substance originated from the surfactant is remaining in these films after calcination. In this way, the formation of mesoporous silica thin films was confirmed.

An in-plane x-ray diffraction analysis was made also for the patterned mesoporous silica films after calcination. The in-plane rotation angle dependence of the (110) plane diffraction intensity was measured, which showed the alignment distribution of about 30°. It was confirmed from these results that the mesostructured silica films formed by the embodiment retained the alignment of the mesochannels almost completely after calcination.

From the above results, it was confirmed that the method of the present invention could form mesoporous silica films with uniaxially aligned pore structure on a substrate at any desired position and in any desired shape.

Effects

As described so far, according to the present invention, a substrate having intrinsic alignment control ability, or a substrate on which a rubbing-treated polymer coating is prepared to provide alignment control ability, or a substrate on which an LB film of polymer compound is prepared to provide alignment control ability is coated with a reactant solution containing surfactants and silicon alkoxides by a coating method such as pen lithography method, ink-jet method, and dip-coating method, and is subsequently dried. With these processes, mesostructured silica film, and mesoporous silica film with uniaxially aligned mesochannels can be formed on a substrate. In these processes, by selectively coating the aforementioned substrates with the reactant solution, patterned mesostructured silica film and mesoporous silica film with uniaxially aligned mesochannels can be formed on a substrate at any desired position and in any desired shape.

What is claimed is:

1. A method of preparing porous materials, comprising the steps of:
(A) making a solution containing silicon and surfactant be in contact with a substrate having alignment control ability; and
(B) drying said substrate made in contact with the solution to remove the solvents contained in said solution.

2. A method according to claim 1, wherein silicon is contained in said solution in a state of compound.

3. A method according to claim 1 or 2, wherein silicon is contained in said solution as silicon alkoxides.

4. A method of preparing porous materials, comprising the steps of:
coating a substrate having alignment control ability with a surfactant solution containing silicon alkoxide; and
drying said substrate.

5. A method according to claim 4, wherein patterned mesostructured silica with uniaxially aligned channel structure is formed by a step of coating a desired position of a substrate having alignment control ability with a surfactant solution containing silicon alkoxide in a desired shape and a step of drying said substrate.

6. A method according to claim 4 or 5, wherein said substrate with alignment control ability is a silicon single crystal substrate having (110) orientation.

7. A method according to claim 4 or 5, wherein said substrate is a substrate whose surface is coated with a polymer compound film subjected to a rubbing process.

8. A method according to claim 4 or 5, wherein said substrate is a substrate whose surface is coated with a Langmuir-Blodgett film of polymer compound.

9. A method according to any one of claims 4 to 8, wherein the substrate is coated with the surfactant solution by a pen lithography method.

10. A method according to any one of claims 4 to 8, wherein the substrate is coated with the surfactant solution by an ink jet method.

11. A method according to any one of claims 4 to 8, wherein the substrate is coated with the surfactant solution by a dip coating method.

12. A method of preparing porous materials, comprising the steps of:
coating a substrate having alignment control ability with a solution of surfactant containing silicon alkoxides;
drying said substrate; and
removing the surfactant.

13. A method according to claim 12, wherein said step of coating said substrate with said solution is a step of selectively coating a desired position of said substrate with said solution in a desired shape.

14. A method according to claim 12 or 13, wherein said substrate with alignment control ability is a silicon single crystal substrate having (110) orientation.

15. A method according to claim 12 or 13, wherein said substrate is a substrate whose surface is coated with a polymer compound film subjected to a rubbing process.

16. A method according to any one of claim 12 or 13, wherein said substrate is a substrate whose surface is coated with a Langmuir-Blodgett film of polymer compound.

17. A method according to any one of claims 12 to 16, wherein said substrate is coated with said surfactant solution by a pen lithography method.

18. A method according to any one of claims 12 to 16, wherein said substrate is coated with said surfactant solution by an ink jet method.

19. A method according to any one of claims 12 to 16, wherein said substrate is coated with said surfactant solution by a dip coating method.

20. A method of preparing porous materials, comprising the steps of:
(A) attaching a solution containing silicon and surfactant to a substrate having alignment control ability; and
(B) removing the solvents contained in said solution attached to said substrate.

21. A method according to claim 20, wherein silicon is contained in said solution in the form of compound.

22. A method according to claim 20, wherein silicon is contained in said solution as silicon alkoxides.
